(19) United States
(12) Patent Application Publication
(10) Pub. No.: US 2026/0346630 A1
(43) Pub. Date: Nov. 5, 2026

(54) PRINTING MEDIUM AND PRINTING MEDIUM SEPARATION METHOD

(71) Applicant: Brother Kogyo Kabushiki Kaisha, Nagoya (JP)

(72) Inventors: Yuji Koga, Nagoya (JP); Kenji Takeuchi, Nagoya (JP); Yoji Tsujishita, Ichinomiya-shi (JP)

(21) Appl. No.: 19/197,704

(22) Filed: May 2, 2025

(51) Int. Cl. B41M 5/50; A44B 1/04; B26F 1/44

(52) U.S. Cl. CPC B41M 5/502; B26F 1/44; A44B 1/04

(57) ABSTRACT

A printing medium is configured to constitute, together with a button member, a button product. The printing medium includes: a connected portion having a sheet shape and configured to be connected to the button member; a remaining portion having a sheet shape and different from the connected portion; and at least one first coupling portion coupling the connected portion to the remaining portion.

### REFERENCE TO RELATED APPLICATIONS

This is a continuation of International Application No. PCT/JP2023/038287 filed on Oct. 24, 2023, and claims priority from Japanese Patent Application No. 2022-177204 filed on Nov. 4, 2022. The entire contents of the aforementioned applications are incorporated herein by reference.

### BACKGROUND ART

The present disclosure relates to a printing medium used for a button product and a printing medium separation method.

As a device for manufacturing a button product such as a button badge to which a predetermined image is applied, and there is a button product manufacturing device that manufactures a button badge by crimping a front lid to a back lid.

### DESCRIPTION

However, a user himself or herself places a transparent film for crimping together with the front lid on the back lid supported by a lower die on a film placement surface of the lower die. Therefore, the user himself or herself can enjoy the production of the button badge by participating in the production, but positioning accuracy of the transparent film may decrease.

Therefore, an object of the present disclosure is to provide a printing medium and a printing medium separation method capable of improving positioning accuracy with respect to a button member in a button product manufacturing device.

In an aspect of the present disclosure, there is provided a printing medium configured to constitute, together with a button member, a button product, the printing medium including: a connected portion having a sheet shape and configured to be connected to the button member; a remaining portion having a sheet shape and different from the connected portion; and at least one first coupling portion coupling the connected portion to the remaining portion.

According to the present disclosure, the remaining portion can be separated from the connected portion by cutting the first coupling portion of the printing medium conveyed onto the button member. Thereby, only the connected portion can be positioned and disposed on the button member with high accuracy.

According to the present disclosure, it is possible to provide the printing medium and the printing medium separation method capable of improving the positioning accuracy with respect to the button member in the button product manufacturing device.

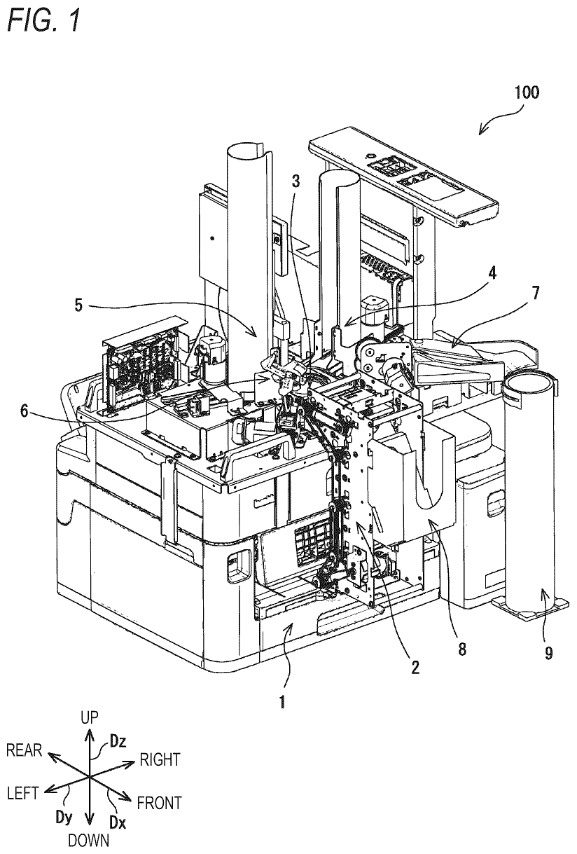

FIG. 1 is a perspective view illustrating a button product manufacturing device in which a printing medium is used according to the present embodiment.

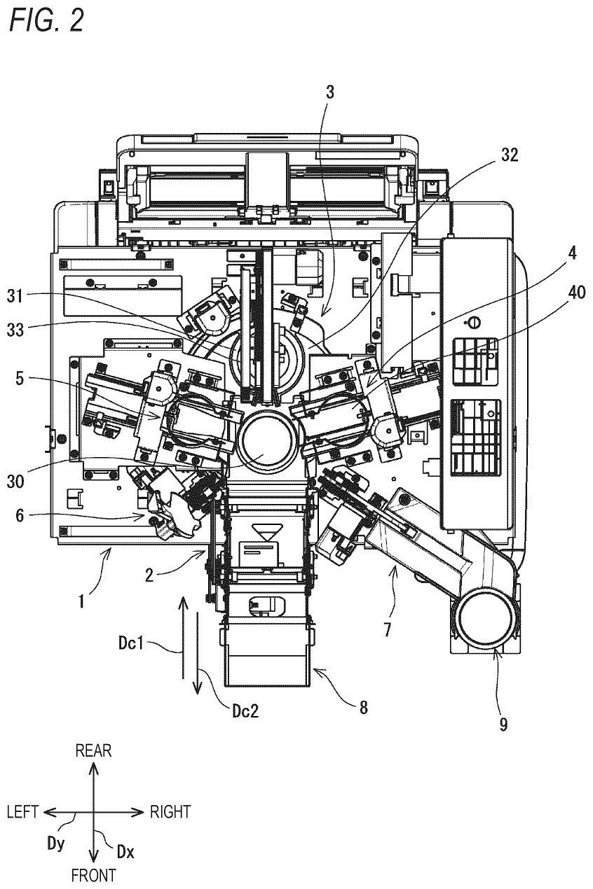

FIG. 2 is a plan view of the button product manufacturing device of FIG. 1.

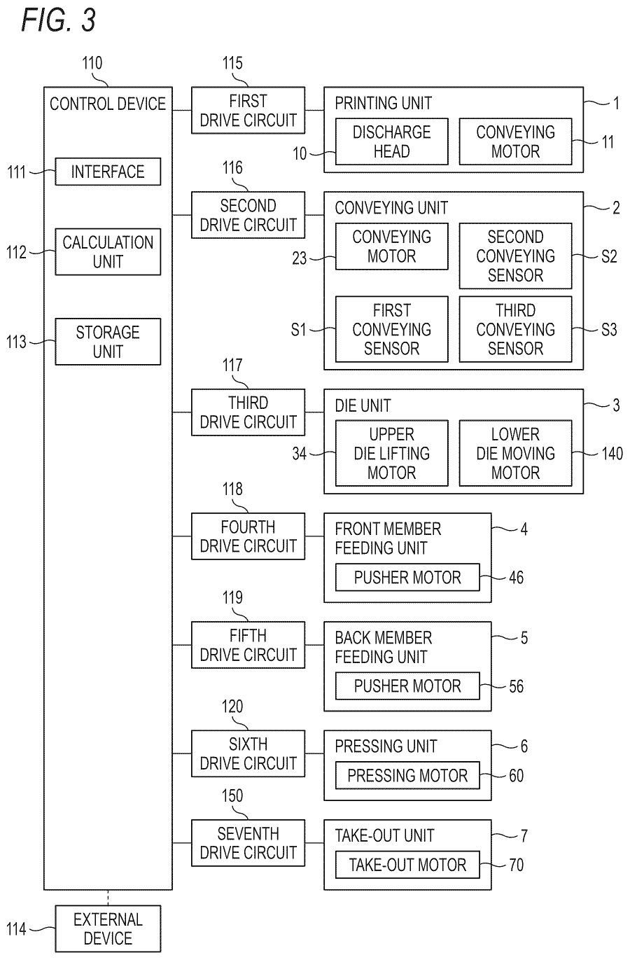

FIG. 3 is a block diagram illustrating a configuration of a control system of the button product manufacturing device of FIG. 1.

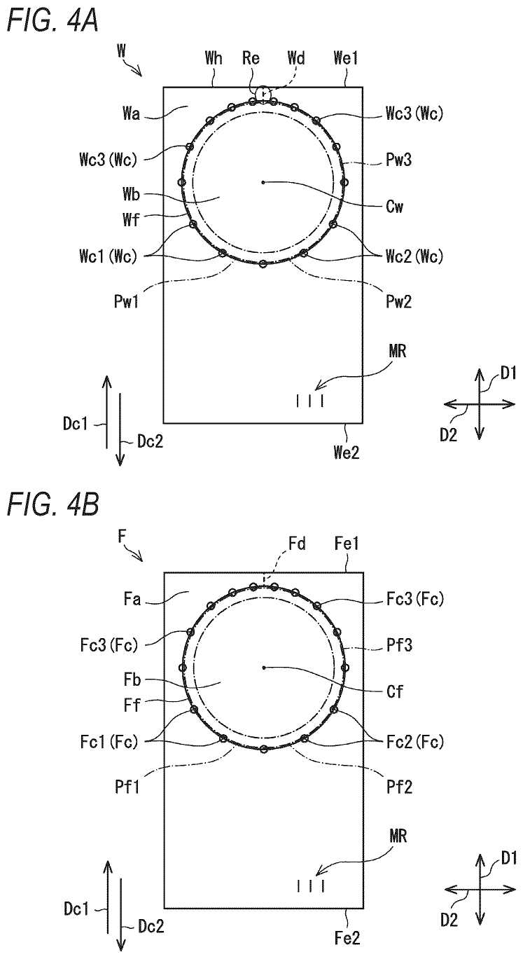

FIG. 4A is a plan view illustrating the printing medium.

FIG. 4B is a plan view illustrating a white film.

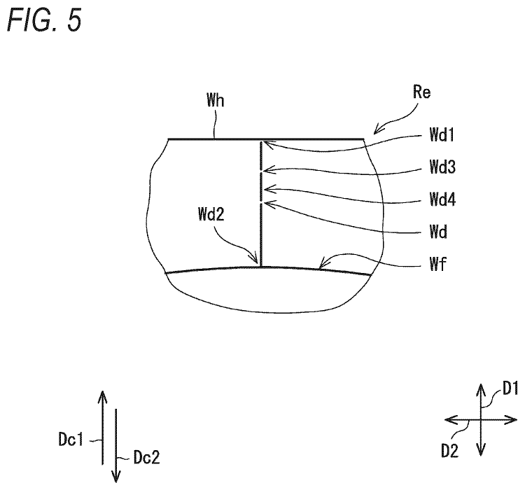

FIG. 5 is an enlarged view of a region in FIG. 4A.

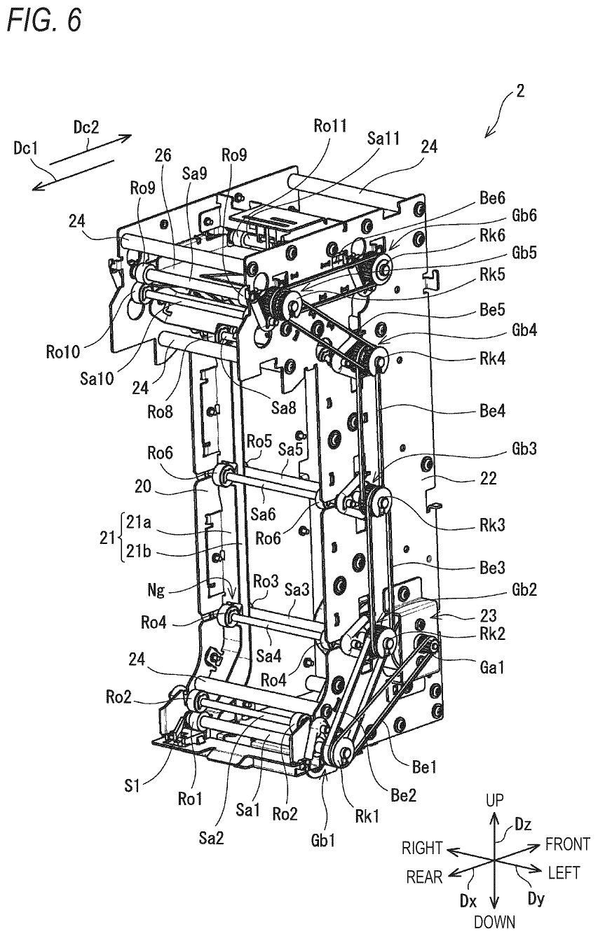

FIG. 6 is a perspective view illustrating a configuration of a conveying unit.

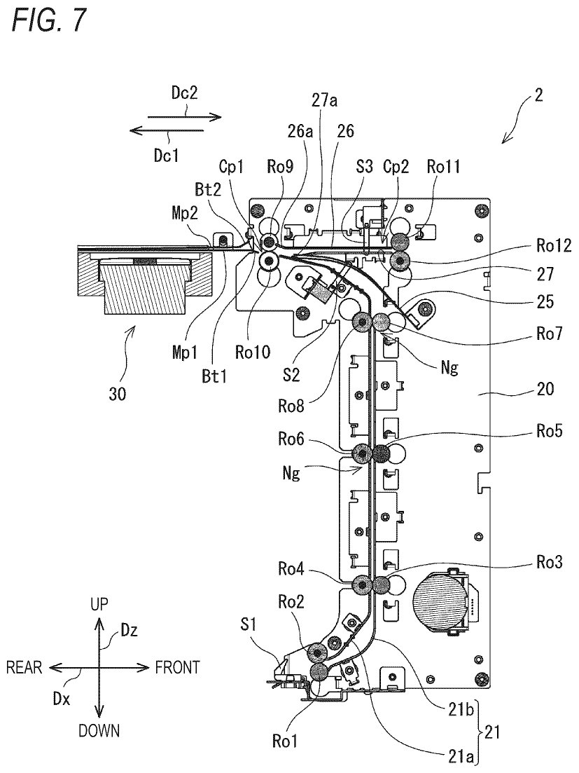

FIG. 7 is a side view of the conveying unit of FIG. 6.

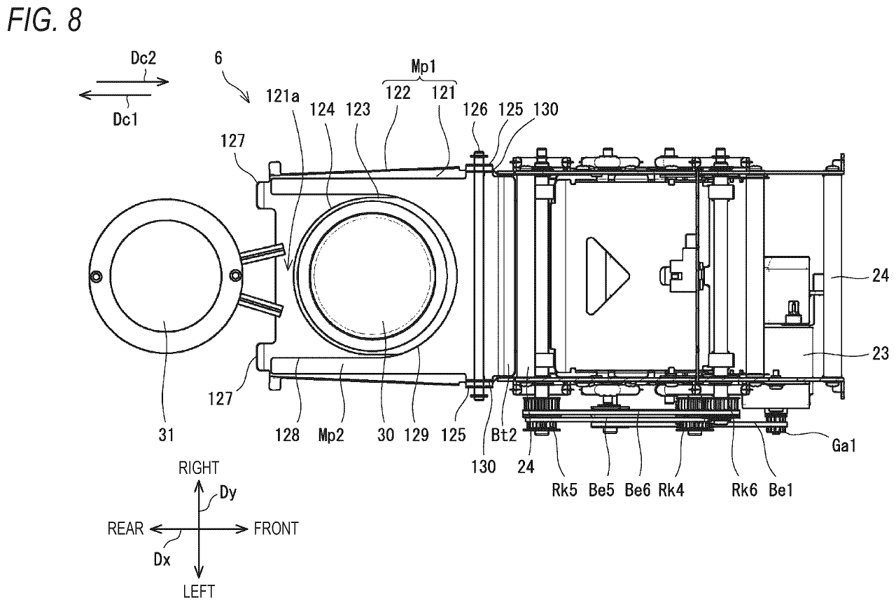

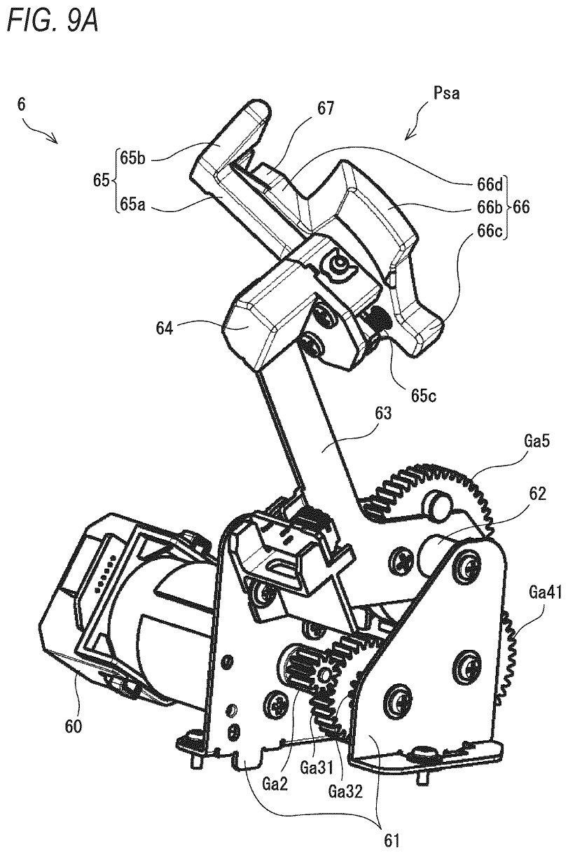

FIG. 8 is a plan view illustrating a lower plate and an upper plate provided on a lower die.

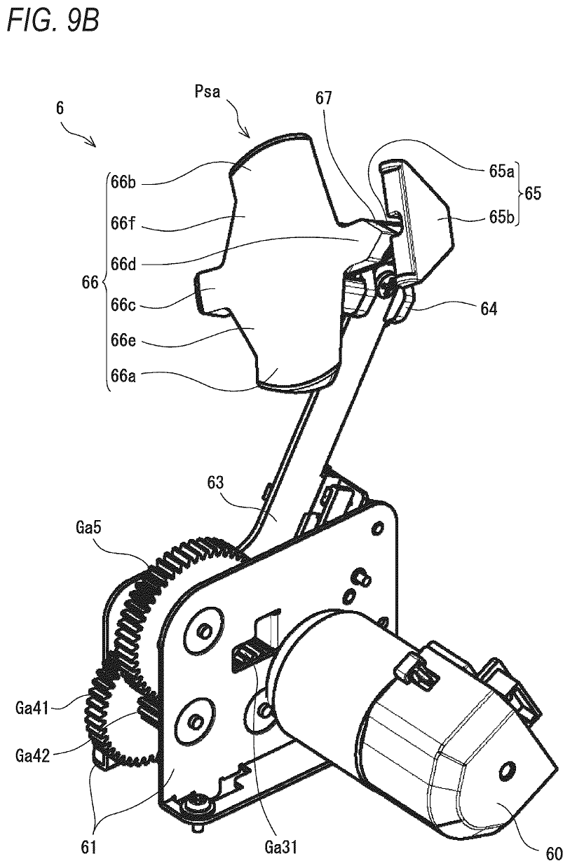

FIG. 9A is a perspective view of a pressing unit.

FIG. 9B is a perspective view of the pressing unit viewed from a direction different from that of FIG. 9A.

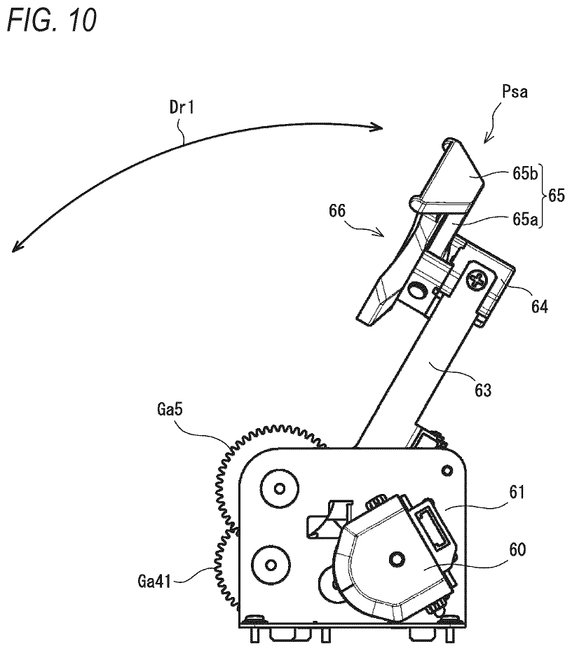

FIG. 10 is a diagram illustrating a standby position of a pressing head of the pressing unit.

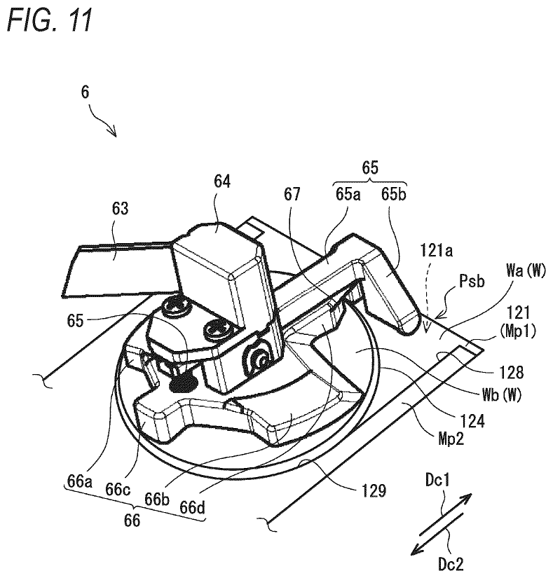

FIG. 11 is a diagram illustrating a pressing position of the pressing head of the pressing unit.

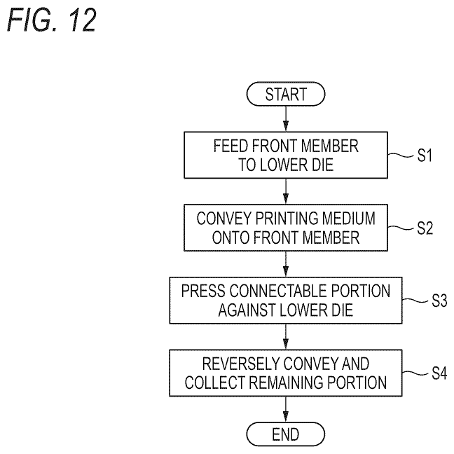

FIG. 12 is a flowchart illustrating a flow of separating a remaining portion of the printing medium from the connected portion and collecting the remaining portion.

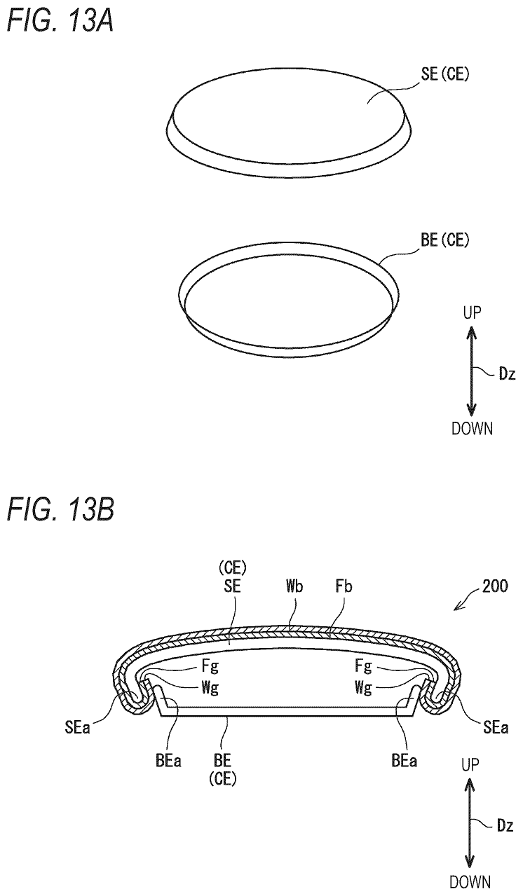

FIG. 13A is a perspective view of a front member and a back member.

FIG. 13B is a cross-sectional view of a button product manufactured by connecting the front member to the back member of FIG. 13A.

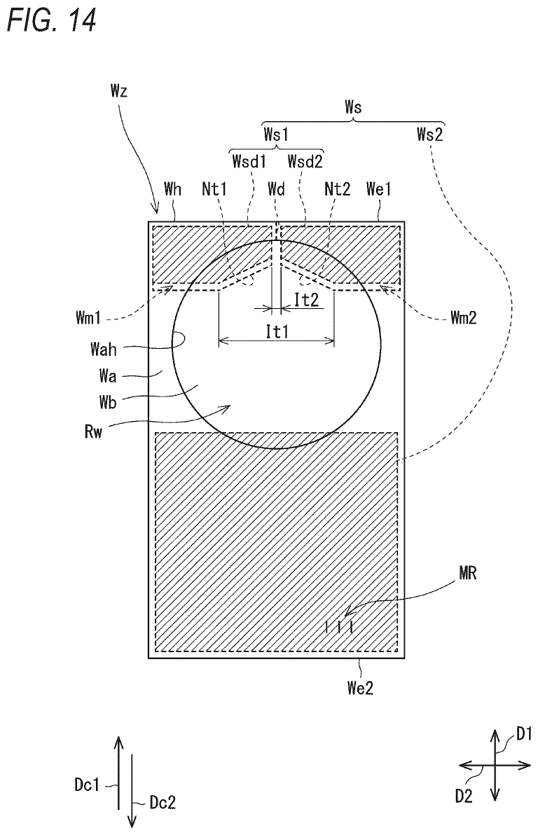

FIG. 14 is a plan view illustrating another example of the printing medium.

Hereinafter, a printing medium according to an embodiment of the present disclosure will be described with reference to the drawings. The printing medium described below is merely an embodiment of the present disclosure. Accordingly, the present disclosure is not limited to the following embodiment, and can be added, deleted, or modified without departing from the scope of the present disclosure.

### Overall Configuration of Button Product Manufacturing Device

First, a button product manufacturing device for manufacturing a button product having a printing medium as one component will be described with reference to the drawings. FIG. 1 is a perspective view illustrating a button product manufacturing device 100 in which the printing medium is used according to an embodiment of the present disclosure. FIG. 2 is a plan view of the button product manufacturing device 100 of FIG. 1. FIG. 3 is a block diagram illustrating a configuration of a control system of the button product manufacturing device 100 of FIG. 1. The button product manufacturing device 100 is a device that manufactures a button product by connecting a front member to a back member constituting the button product, for example, by crimping the front member and the back member. As illustrated in FIGS. 1 and 2, the button product manufacturing device 100 includes a printing unit 1, a conveying unit 2, a die unit 3, a front member feeding unit 4, a back member feeding unit 5, a pressing unit 6, a take-out unit 7, a collection box 8, and a button product container 9. In FIGS. 1 and 2, directions orthogonal to one another are referred to as a first direction Dx, a second direction Dy, and a third direction Dz. In the present embodiment, for example, the first direction Dx is a front-rear direction of the button product manufacturing device 100, the second direction Dy is a left-right direction of the button product manufacturing device 100, and the third direction Dz is an up-down direction. In this case, a front side of the printing unit 1 is referred to as a front side, a back side thereof is referred to as a rear side, and left and right sides thereof when viewed from the front side are referred to as a left side and a right side. In the following description, Dx is referred to as a front-rear direction, Dy is referred to as a left-right direction, and Dz is referred to as an up-down direction.

The printing unit 1 is disposed below the die unit 3, the front member feeding unit 4, the back member feeding unit 5, the pressing unit 6, and the take-out unit 7. The printing unit 1 is an inkjet printer that prints an image on a printing medium W (FIG. 4A to be described later) such as a transparent film. The printing unit 1 performs printing on the printing medium W. Specifically, the printing unit 1 includes a discharge head 10, and performs printing by discharging ink droplets onto the printing medium W by the discharge head 10. The printing unit 1 includes a conveying motor 11 that drives a conveyance roller. The discharge head 10 may be of a serial head type or a line head type.

The printing unit 1 includes a sheet holder (not illustrated) that holds the plurality of printing media W and a plurality of white films F (FIG. 4B to be described later), and the printing media W and the white films F are held on the sheet holder as a bundle in which the printing media W and the white films F are alternately stacked. The white film F is fed to the conveying unit 2 without being printed by the printing unit 1, and the printing medium W is fed to the conveying unit 2 after a predetermined image is printed by the discharge head 10 of the printing unit 1. The predetermined image is an inverted image that becomes a normal image when a user views the image from a surface opposite to the surface on which the image is printed among the surfaces of the printing medium W. In the present embodiment, an example in which the printing unit 1 is an inkjet printer has been described, but the printing unit 1 is not limited thereto, and may be another printer such as a laser printer or a thermal printer.

Regarding the conveying unit 2, a part of the conveying unit 2 is disposed in front of the printing unit 1, and the entire conveying unit 2 is disposed in front of the die unit 3. The conveying unit 2 conveys, along a conveying direction Dc1 toward the die unit 3, the printing medium W and the white film F, which will be described later, conveyed from the printing unit 1 onto a front member SE (FIG. 13A), which will be described later, fed in advance to a lower die 30 provided in the die unit 3. The conveying unit 2 will be described in detail later.

The die unit 3 connects the front member SE to a back member BE (FIG. 13A) to be described later, for example, by crimping the front member SE and the back member BE. The front member SE is formed of a magnetic material such as a tin-plated steel plate. The back member BE is formed of a magnetic material such as a tin-plated steel plate. The front member SE and the back member BE are included in a button member CE (FIG. 13A) constituting a button product 200 (FIG. 13B) to be described later. The die unit 3 includes the lower die 30, a lower die 31, a rotation support table 32, an upper die 33, an upper die lifting motor 34 (FIG. 3), and a lower die moving motor 140 (FIG. 3). The lower die 30 and the lower die 31 are formed in a circular shape in a plan view, and are supported by the rotation support table 32. The lower die 30 and the lower die 31 are disposed to face each other with respect to the center of the rotation support table 32. The upper die 33 moves up and down to approach or separate from either the lower die 30 or the lower die 31 in the up-down direction Dz based on an operation of the upper die lifting motor 34.

The rotation support table 32 pivots in the up-down direction Dz based on an operation of the lower die moving motor 140. By pivoting the rotation support table 32, either the lower die 30 or the lower die 31 can be located at a position facing the upper die 33 in the up-down direction Dz (hereinafter, referred to as a second die position). A position facing the second die position in the front-rear direction Dx is hereinafter referred to as a first die position. When the lower die 30 is at the first die position, the front member SE is fed to the lower die 30 by the front member feeding unit 4. After the white film F is conveyed onto the front member SE by the conveying unit 2, first cutting processing and first separation processing to be described later are performed. Thus, only the connected portion Fb of the white film F is disposed on the front member SE. Subsequently, after the printing medium W is conveyed onto the connected portion Fb on the front member SE by the conveying unit 2, second cutting processing and second separation processing to be described later are performed. Accordingly, only a connected portion Wb of the printing medium W is disposed on the connected portion Fb. That is, the connected portion Fb and the connected portion Wb are disposed in this order on the front member SE.

Next, the lower die 30 supporting the front member SE and located at the first die position is located at the second die position by pivoting the rotation support table 32. At this time, the lower die 31 at the second die position moves to the first die position. Then, the upper die 33 is lowered, and the front member SE supported by the lower die 30 is held by the upper die 33. At this time, the back member BE is fed to the lower die 31 by the back member feeding unit 5. Subsequently, the lower die 31 at the first die position is located at the second die position by pivoting the rotation support table 32. Thereafter, the upper die 33 holding the front member SE is lowered toward the lower die 31 supporting the back member BE, thereby manufacturing the button product 200 in which the front member SE is crimped to the back member BE. Thereafter, the lower die 31 at the second die position is located at the first die position by pivoting the rotation support table 32. Then, the button product 200 supported by the lower die 31 moved to the first die position is taken out by the take-out unit 7 to be described later.

The front member feeding unit 4 is disposed above the printing unit 1 and to the right of the die unit 3. The front member feeding unit 4 includes a pusher motor 46 (FIG. 3). The front member feeding unit 4 feeds the front member SE to the lower die 30 when a pusher (not illustrated) pushes out the front member SE based on an operation of the pusher motor 46.

The back member feeding unit 5 is disposed above the printing unit 1 and to the left of the die unit 3. The back member feeding unit 5 includes a pusher motor 56 (FIG. 3). The back member feeding unit 5 feeds the front member SE to the lower die 31 when a pusher (not illustrated) pushes out the front member SE based on an operation of the pusher motor 56.

The pressing unit 6 is disposed in front of the front member feeding unit 4 and the back member feeding unit 5 and to the left of the die unit 3. The pressing unit 6 includes a pressing motor 60 (FIG. 3). The pressing unit 6 presses the printing medium W and the white film F toward the lower die 30 based on an operation of the pressing motor 60. The pressing unit 6 will be described in detail later.

The take-out unit 7 is disposed in front of the front member feeding unit 4. The take-out unit 7 includes a take-out motor 70 (FIG. 3). The take-out unit 7 takes out the button product 200 from the lower die 31 based on an operation of the take-out motor 70, and guides the button product 200 to the button product container 9 disposed in front of the take-out unit 7.

As illustrated in FIG. 3, the button product manufacturing device 100 further includes a control device 110, a first drive circuit 115, a second drive circuit 116, a third drive circuit 117, a fourth drive circuit 118, a fifth drive circuit 119, a sixth drive circuit 120, and a seventh drive circuit 150. The control device 100 includes an interface 111, a calculation unit 112, and a storage unit 113. The interface 111 receives various types of data such as image data from an external device 114 such as a computer, a camera, a communication network, a recording medium, a display, and a printer. The control device 110 may be implemented by a single device, or may have a configuration in which a plurality of devices are arranged in a distributed manner and cooperate with one another to operate the button product manufacturing device 100.

The storage unit 113 is a memory accessible from the calculation unit 112, and includes a RAM and a ROM. The RAM temporarily stores various types of data including data received from the external device 114 such as image data, data converted by the calculation unit 112, and the like. The ROM stores a button product manufacturing program for performing various types of processing, predetermined data, and the like. The button product manufacturing program may be stored in an external storage medium different from the storage unit 113 and accessible from the calculation unit 112, such as a CD-ROM.

The calculation unit 112 includes at least one circuit, for example, a processor such as a CPU, and an integrated circuit such as an ASIC. The calculation unit 112 controls each unit by executing the button product manufacturing program.

The control device 110 outputs a control signal to the first drive circuit 115. The first drive circuit 115 generates a drive signal based on the control signal and outputs the drive signal to the discharge head 10 of the printing unit 1. The discharge head 10 is driven in response to a drive signal, which causes ink droplets to be discharged from nozzles. Specifically, the first drive circuit 115 causes the ink droplets to discharge the discharge head 10 onto the printing medium W while moving the discharge head 10 in a predetermined movement direction based on the image data acquired from the external device 114. The first drive circuit 115 drives the conveying motor 11 to convey the printing medium W in a predetermined conveying direction. As described above, the first drive circuit 115 alternately repeats the printing pass and the convey operation, so that an image based on the image data is printed on the printing medium W.

The control device 110 outputs a control signal to the second drive circuit 116. The second drive circuit 116 generates a drive signal based on the control signal and controls an operation of a conveying motor 23 provided in the conveying unit 2. In this case, the second drive circuit 116 controls the operation of the conveying motor 23 based on detection results of a first conveying sensor S1, a second conveying sensor S2, and a third conveying sensor S3 provided in the conveying unit 2.

The control device 110 outputs a control signal to the third drive circuit 117. The third drive circuit 117 generates a drive signal based on the control signal and controls each operation of the upper die lifting motor 34 and the lower die moving motor 140 provided in the die unit 3. The control device 110 outputs a control signal to the fourth drive circuit 118. The fourth drive circuit 118 generates a drive signal based on the control signal and controls the operation of the pusher motor 46 provided in the front member feeding unit 4. Further, the control device 110 outputs a control signal to the fifth drive circuit 119. The fifth drive circuit 119 generates a drive signal based on the control signal and controls the operation of the pusher motor 56 provided in the back member feeding unit 5. The control device 110 outputs a control signal to the sixth drive circuit 120. The sixth drive circuit 120 generates a drive signal based on the control signal and controls the operation of the pressing motor 60 provided in the pressing unit 6. The control device 110 outputs a control signal to the seventh drive circuit 150. The seventh drive circuit 150 generates a drive signal based on the control signal and controls the operation of the take-out motor 70 provided in the take-out unit 7.

### Printing Medium and White Film

Next, the printing medium W and the white film F conveyed from the printing unit 1 toward the lower die 30 by the conveying unit 2 will be described. FIG. 4A is a plan view illustrating the printing medium W, and FIG. 4B is a plan view illustrating the white film F. FIG. 5 is an enlarged view of a region Re in FIG. 4A.

The printing medium W constitutes the button product 200 together with the button member CE (that is, the front member SE and the back member BE), and is, for example, a transparent sheet. As illustrated in FIG. 4A, the printing medium W has a rectangular shape. The printing medium W has one end We1 in a direction D1 (corresponding to a predetermined direction) parallel to the conveying direction Dc1 when being conveyed toward the die unit 3 by the conveying unit 2, and the other end We2 opposite to the one end We1. In the conveying direction Dc1, the one end We1 of the printing medium W corresponds to a downstream end, and the other end We2 corresponds to an upstream end.

The printing medium W includes a sheet-shaped connected portion Wb connected to the front member SE and the back member BE by the die unit 3, a sheet-shaped remaining portion Wa different from the connected portion Wb, and a plurality of first coupling portions Wc coupling the connected portion Wb to the remaining portion Wa. The remaining portion Wa is disposed to surround the connected portion Wb. Accordingly, the remaining portion Wa has the one end We1 and the other end We2 in the direction D1. The printing medium W has the plurality of first coupling portions Wc and first cut portions Wf each located between the adjacent first coupling portions Wc on a boundary between the connected portion Wb and the remaining portion Wa. Accordingly, the connected portion Wb and the remaining portion Wa are cut and not coupled between the adjacent first coupling portions Wc. The connected portion Wb has, for example, a circular shape in a plan view and is located closer to the one end We1 than to the other end We2. That is, the connected portion Wb is unevenly distributed toward the one end We1 with respect to the remaining portion Wa. The connected portion Wb after the second cutting processing to be described later has the same size as the connected portion Fb of the white film F or is larger than the connected portion Fb.

The printing medium W further includes a linear weak portion Wd extending from an edge portion Wh of the one end We1 to the connected portion Wb. The first coupling portion Wc and the linear weak portion Wd form a weak portion having lower strength than the connected portion Wb and the remaining portion Wa. Specifically, it is exemplified that the linear weak portion Wd and a combination of the first coupling portion Wc and the first cut portion Wf are formed by perforations having the same thickness as the connected portion Wb and the remaining portion Wa but are partially cut. Further, as another example, the first coupling portion Wc and the linear weak portion Wd are recesses or the like having a thickness thinner than that of the connected portion Wb and the remaining portion Wa.

When the linear weak portion Wd is formed by the perforation, as illustrated in FIG. 5, the linear weak portion Wd has a plurality of second coupling portions Wd3 coupling portions of the remaining portion Wa located on both sides of the linear weak portion Wd in a direction D2 orthogonal to the direction D1 to each other, and a plurality of second cut portions Wd4 by which the portions of the remaining portion Wa are cut. The first cut portion Wf and the second cut portion Wd4 are continuous with each other. More specifically, among the plurality of second cut portions Wd4, the second cut portion Wd4 located closest to the first cut portion Wf is continuous with the first cut portion Wf. Thus, in the region Re, the connected portion Wb is cut in an inverted T shape with respect to the remaining portion Wa. On the other hand, the linear weak portion Wd has an edge side coupling portion Wd1 coupled to the edge portion Wh of the remaining portion Wa. The portions of the remaining portion Wa on both sides of the linear weak portion Wd in the direction D2 correspond to first and second remaining areas of the remaining portion.

The first coupling portions Wc includes coupling portions Wc1, coupling portions Wc2, and coupling portions Wc3. The coupling portion Wc1 couples the connected portion Wb to the remaining portion Wa in a predetermined range Pw1 on the boundary between the connected portion Wb and the remaining portion Wa. The coupling portion Wc2 couples the connected portion Wb to the remaining portion Wa in a range Pw2 on the boundary different from the range Pw1. The coupling portion Wc3 couples the connected portion Wb to the remaining portion Wa in a range Pw3 on the boundary different from the ranges Pw1 and Pw2. A portion of the connected portion Wb in the range Pw1 is pressed toward the lower die 30 by a first pressing portion 66e to be described later provided in the pressing unit 6, and a portion of the connected portion Wb in the range Pw2 is pressed toward the lower die 30 by a second pressing portion 66f to be described later. The range Pw3 corresponds to a first range, and the ranges Pw1 and Pw2 correspond to second ranges.

More first coupling portions Wc are provided in a predetermined range Pw3 on the boundary between the connected portion Wb and the remaining portion Wa than in the range Pw1 and the range Pw2. That is, the number of the coupling portions Wc3 is larger than the total number of the coupling portions Wc1 and the coupling portions Wc2. The two coupling portions Wc present on a straight line orthogonal to the conveying direction Dc1 and passing through a center Cw of the connected portion Wb may be included in the coupling portion Wc1 and the coupling portion Wc2, or may be included in the coupling portion Wc3. Each of the coupling portions Wc1 corresponds to a first-range coupling portion, and each of the coupling portions Wc2 corresponds to a second-range coupling portion, and each of the coupling portions Wc3 corresponds to the second-range coupling portion. Two or more first-range coupling portions may be provided on the boundary, and one or more second-range coupling portions may be provided on the boundary.

Here, the remaining portion Wa is provided with a mark portion MR disposed on one side of the direction D2 with the center in the direction D2 as a reference. The mark portion MR may be, for example, three line segments extending in the direction D1 and arranged side by side in the direction D2.

A configuration of the white film F is basically the same as a configuration of the printing medium W. The white film F constitutes the button product 200 together with the button member CE in the same manner as the printing medium W. As illustrated in FIG. 4B, the white film F has a rectangular shape. The white film F has one end Fe1 in the direction D1 and the other end Fe2 opposite to the one end Fe1. In the conveying direction Dc1, the one end Fe1 of the white film F corresponds to a downstream end, and the other end Fe2 corresponds to an upstream end.

The white film F includes a sheet-shaped connected portion Fb connected to the front member SE and the back member BE by the die unit 3, a sheet-shaped remaining portion Fa different from the connected portion Fb, and a plurality of first coupling portions Fc coupling the connected portion Fb to the remaining portion Fa. The remaining portion Fa is disposed to surround the connected portion Fb. Accordingly, the remaining portion Fa has the one end Fe1 and the other end Fe2 in the direction D1. The white film F has the plurality of first coupling portions Fc and first cut portions Ff each located between the adjacent first coupling portions Fc at a boundary between the connected portion Fb and the remaining portion Fa. Accordingly, the connected portion Fb and the remaining portion Fa are cut and not connected between the adjacent first coupling portions Fc. Further, the connected portion Fb has, for example, a circular shape in a plan view and is located closer to the one end Fe1 than to the other end Fe2. That is, the connected portion Fb is unevenly distributed toward the one end Fe1 with respect to the remaining portion Fa.

The white film F further includes a linear weak portion Fd extending from the one end Fe1 to the connected portion Fb. The first coupling portion Fc and the linear weak portion Fd form a weak portion having lower strength than the connected portion Fb and the remaining portion Fa. Specifically, it is exemplified that the linear weak portion Fd and a combination of the first coupling portion Fc and the first cut portion Ff and are formed by perforations having the same thickness as the connected portion Fb and the remaining portion Fa but are partially cut. Further, as another example, the first coupling portion Fc and the linear weak portion Fd are recesses or the like having a thickness thinner than that of the connected portion Fb and the remaining portion Fa. Since a configuration of the linear weak portion Fd formed by perforation is the same as the configuration of the linear weak portion Wd in FIG. 5 described above, the description thereof will be omitted.

The first coupling portion Fc includes coupling portions Fc1, coupling portions Fc2, and coupling portions Fc3. The coupling portion Fc1 couples the connected portion Fb to the remaining portion Fa in a range Pf1 that is a range on the boundary between the connected portion Fb and the remaining portion Fa and corresponds to the range Pw1. The coupling portion Fc2 couples the connected portion Fb to the remaining portion Fa in a range Pf2 that is a range on the boundary and corresponds to the range Pw2. The coupling portion Fc3 couples the connected portion Fb to the remaining portion Fa in a range Pf3 that is a range on the boundary and corresponds to the range Pw3. A portion of the connected portion Fb in the range Pf1 is pressed toward the lower die 30 by the first pressing portion 66e to be described later provided in the pressing unit 6, and a portion of the connected portion Fb in the range Pf2 is pressed toward the lower die 30 by the second pressing portion 66f to be described later.

More first coupling portions Fc are provided in a predetermined range Pf3 on the boundary between the connected portion Fb and the remaining portion Fa than in the range Pf1 and the range Pf2. That is, the number of the coupling portions Fc3 is larger than the total number of coupling portions Fc1 and coupling portions Fc2. The two coupling portions Fc present on a straight line orthogonal to the conveying direction Dc1 and passing through a center Cf of the connected portion Fb may be included in the coupling portion Fc1 and the coupling portion Fc2, or may be included in the coupling portion Fc3.

The remaining portion Fa is provided with a mark portion MR disposed on one side of the direction D2 with the center in the direction D2 as a reference. The mark portion MR may be, for example, three line segments extending in the direction D1 and arranged side by side in the direction D2. The mark portion MR may be disposed on the other side of the direction D2 with the center of the remaining portion Fa in the direction D2 as a reference.

### Conveying Unit

Next, the conveying unit 2 will be described. FIG. 6 is a perspective view illustrating a configuration of the conveying unit 2. FIG. 7 is a side view of the conveying unit 2 in FIG. 6.

The conveying unit 2 conveys the remaining portion Wa of the printing medium W and the remaining portion Fa of the white film F to the collection box 8 along a conveying direction Dc2 that is a direction opposite to the conveying direction Dc1 described above. Accordingly, the remaining portion Wa of the printing medium W and the remaining portion Fa of the white film F are collected in the collection box 8 as waste portions. In the present embodiment, film conveying processing is executed in which the white film F is conveyed by the conveying unit 2 so as to be placed on the front member SE held by the lower die 30 prior to the printing medium W. Since a conveying method of the printing medium W by the conveying unit 2 is the same as a conveying method of the white film F, the conveying of the printing medium W will be representatively described below.

As illustrated in FIGS. 6 and 7, the conveying unit 2 includes support plates 20 and 22, a pair of conveying guides 21, a conveying motor 23, drive rollers Rk1 to Rk6, and endless drive belts Be1 to Be6.

The support plates 20 and 22 extend in the up-down direction Dz and are spaced apart from each other in the left-right direction Dy. The support plate 20 and the support plate 22 are coupled by a plurality of plate coupling shafts 24 extending in the left-right direction Dy. The support plate 20 is provided with a conveying guide 21 that curves forward from a rear portion of a lower end of the support plate 20 and extends upward. The conveying guide 21 is also provided on the support plate 22. The conveying guide 21 includes a first guide body portion 21a and a second guide body portion 21b. A groove-shaped space is provided between the first guide body portion 21a and the second guide body portion 21b, and end portions of the printing medium W in the left-right direction Dy are inserted into the space during conveying. The first guide body portion 21a is bent or curved forward from the rear portion of the lower end of the support plate 20, extends upward, and is bent or curved rearward. The second guide body portion 21b is bent or curved forward from the rear portion of the lower end of the support plate 20 and extends upward. The first guide body portion 21a is disposed rearward of the second guide body portion 21b as a whole.

The conveying motor 23 is provided on the support plate 22. A drive gear Ga1 is connected to a rotation shaft of the conveying motor 23. The drive rollers Rk1 to Rk6 are provided on the support plate 22. A drive gear Gb1 is connected to a rotation shaft of the drive roller Rk1. A drive gear Gb2 is connected to a rotation shaft of the drive roller Rk2. A drive gear Gb3 is connected to a rotation shaft of the drive roller Rk3. A drive gear Gb4 is connected to a rotation shaft of the drive roller Rk4. A drive gear Gb5 is connected to a rotation shaft of the drive roller Rk5. A drive gear Gb6 is connected to a rotation shaft of the drive roller Rk6. The drive rollers Rk1 to Rk6 are located to the left of the support plate 22. The drive roller Rk1 is disposed behind and below the drive gear Ga1. The drive roller Rk2 is disposed in front of the drive roller Rk1 and behind the drive gear Ga1 and above the drive roller Rk1. The drive roller Rk3 is disposed above the drive roller Rk2. The drive roller Rk4 is disposed above the drive roller Rk3. The drive roller Rk5 is disposed behind and above the drive roller Rk4. The drive roller Rk6 is disposed in front of the drive roller Rk5. The drive belt Be1 is stretched around the drive gear Ga1 and the drive gear Gb1. The drive belt Be2 is stretched around the drive gear Gb1 and the drive gear Gb2. The drive belt Be3 is stretched around the drive gear Gb2 and the drive gear Gb3. The drive belt Be4 is stretched around the drive gear Gb3 and the drive gear Gb4. The drive belt Be5 is stretched around the drive gear Gb4 and the drive gear Gb5. The drive belt Be6 is stretched around the drive gear Gb5 and the drive gear Gb6. With such a configuration, a drive force of the conveying motor 23 is transmitted to the drive roller Rk1, the drive roller Rk2, the drive roller Rk3, the drive roller Rk4, the drive roller Rk5, and the drive roller Rk6 via the drive belts Be1 to Be6.

The first guide body portion 21a and the second guide body portion 21b are provided with cuts Ng corresponding to the drive rollers Rk2 to Rk4, respectively. The drive roller Rk1 includes a drive shaft Sa1 extending in the left-right direction Dy and a pair of drive-side rollers Ro1. A pair of driven-side rollers Ro2 are provided to face the pair of drive-side rollers Ro1, respectively. Each of the pair of driven-side rollers Ro2 is coupled to the driven shaft Sa2. The drive roller Rk2 includes a drive shaft Sa3 extending in the left-right direction Dy and a pair of drive-side rollers Ro3. A pair of driven-side rollers Ro4 are provided to face the pair of drive-side rollers Ro3, respectively. Each of the pair of driven-side rollers Ro4 is coupled to the driven shaft Sa4. The pair of drive-side rollers Ro3 are disposed in the cut Ng of the first guide body portion 21a, and the pair of driven-side rollers Ro4 are disposed in the cut Ng of the second guide body portion 21b. Each end portion of the printing medium W in the left-right direction Dy is clamped between the drive-side roller Ro3 and the driven-side roller Ro4. A configuration corresponding to the drive roller Rk5 or Rk6 (that is, a pair of drive-side rollers, a pair of driven-side rollers, a drive shaft, and a driven shaft) is the same as the above configuration corresponding to the drive roller Rk1, and thus the description thereof will be omitted. A configuration corresponding to the drive roller Rk3 or Rk4 (that is, a pair of drive-side rollers, a pair of driven-side rollers, a drive shaft, and a driven shaft) is the same as the above configuration corresponding to the drive roller Rk2, and thus the description thereof will be omitted.

When the conveying motor 23 is driven, the drive force of the conveying motor 23 is transmitted to the drive rollers Rk1 to Rk6. Accordingly, the printing medium W is conveyed to the lower die 30 by the rotation of the drive-side rollers Ro1 and the driven-side rollers Ro2, the rotation of the drive-side rollers Ro3 and the driven-side rollers Ro4, the rotation of drive-side rollers Ro5 and driven-side rollers Ro6, the rotation of drive-side rollers Ro7 and driven-side rollers Ro8, and the rotation of drive-side rollers Ro9 and driven-side rollers Ro10.

Here, as illustrated in FIG. 7, a conveying guide piece 25 is disposed, between the support plate 20 and the support plate 22, above the second guide body portion 21b and in front of the first guide body portion 21a as a whole. The conveying guide piece 25 has flexibility and is made of, for example, a resin. A base end of the conveying guide piece 25 is fixed to the support plates 20 and 22, and a front end of the conveying guide piece 25 is a free end. The front end of the conveying guide piece 25 faces the first guide body portion 21a. A distance between the conveying guide piece 25 and the first guide body portion 21a decreases toward the rear, that is, toward the lower die 30. The printing medium W is guided toward the drive-side rollers Ro9 and the driven-side rollers Ro10 by the first guide body portion 21a and the conveying guide piece 25. Thereafter, the printing medium W is conveyed to the lower die 30 along the conveying direction Dc1 by the drive-side rollers Ro9 and the driven-side rollers Ro10. As described above, the first guide body portion 21a, the second guide body portion 21b, and the conveying guide piece 25 constitute a first conveying path Cp1 of the printing medium W toward the lower die 30 of the die unit 3.

The first conveying sensor S1, which is, for example, a contact sensor, is provided behind the drive-side roller Ro1 and the driven-side roller Ro2. The second conveying sensor S2, which is, for example, a contact sensor, is provided between the first guide body portion 21a and the conveying guide piece 25. The second drive circuit 116 drives the conveying motor 23 when the printing medium W fed from the printing unit 1 is detected by the first conveying sensor S1. When a downstream end of the printing medium W is detected by the second conveying sensor S2, the second drive circuit 116 controls driving of the conveying motor 23 based on a rotation amount of the conveying motor 23 detected by an encoder (not illustrated) immediately after the detection. Accordingly, the printing medium W is conveyed to a predetermined position of the die unit 3 with high accuracy.

A conveying guide 26 and a conveying guide piece 27 are provided between the drive-side roller Ro9 and the driven-side roller Ro10, and a drive-side roller Ro11 and a driven-side roller Ro12. The conveying guide 26 is located above the conveying guide piece 27. The conveying guide 26 extends in the front-rear direction Dx. A rear end (that is, an end portion on a lower die 30 side) 26a of the conveying guide 26 is formed to be bent upward. On the other hand, the conveying guide piece 27 has flexibility and is made of, for example, a resin. The conveying guide piece 27 extends in the front-rear direction Dx. A rear end 27a of the conveying guide piece 27 is located in front of the rear end 26a of the conveying guide 26. The rear end 27a of the conveying guide piece 27 is formed to be bent downward. The conveying guide piece 27 intersects the first conveying path Cp1 in a side view illustrated in FIG. 7. In such a configuration, the conveying guide 26 and the conveying guide piece 27 constitute a second conveying path Cp2 of the remaining portion Wa and Fa from the lower die 30 of the die unit 3 toward the collection box 8.

When the printing medium W is conveyed along the first conveying path Cp1, a lower surface of the conveying guide piece 27 is pressed by a downstream-side end portion of the printing medium W and is bent upward. Accordingly, the conveying guide piece 27 allows conveyance of the printing medium W from the drive-side roller Ro7 and the driven-side roller Ro8 to the drive-side roller Ro9 and the driven-side roller Ro10. When the printing medium W is conveyed in the conveying direction Dc1 and reaches a predetermined position of the lower die 30, an upstream-side end portion of the printing medium W is in a state of being gripped by the drive-side roller Ro9 and the driven-side roller Ro10 and is in a state of being located on a downstream side with respect to the conveying guide piece 27 in the first conveying path Cp1. At this time, the conveying guide piece 27 returns to the state of intersecting the first conveying path Cp1 again due to its flexibility.

As described above, cutting processing of cutting the printing medium W conveyed to the predetermined position of the lower die 30 into the connected portion Wb and the remaining portion Wa is performed by the pressing unit 6 to be described later. Thereafter, separation processing of separating the remaining portion Wa from the connected portion Wb and discarding only the remaining portion Wa is performed. In the separation processing, the second drive circuit 116 reversely rotates the conveying motor 23 in a state in which the connected portion Wb is pressed against the front member SE disposed on the lower die 30 by the pressing unit 6. In this case, the drive force of the conveying motor 23 (that is, the drive force generated by the reverse rotation) is transmitted to the drive roller Rk5 and the drive roller Rk6 via the drive rollers Rk1 to Rk4. Accordingly, the remaining portion Wa is separated from the connected portion Wb. The remaining portion Wa is conveyed in the conveying direction Dc2 after the separation, is guided to the second conveying path Cp2 by coming into contact with an outer surface of the conveying guide piece 27, and is conveyed toward the drive-side roller Ro11 and the driven-side roller Ro12. In this case, since the rear end 27a of the conveying guide piece 27 is bent downward, the remaining portion Wa is easily guided to the second conveying path Cp2. Thereafter, the remaining portion Wa is conveyed while the edge portion We2 of the remaining portion Wa is clamped between the drive-side roller Ro11 and the driven-side roller Ro12, and is collected in the collection box 8.

The third conveying sensor S3, which is, for example, a contact sensor, is provided in front of the drive-side roller Ro9 and the driven-side roller Ro10 and behind the drive-side roller Ro11 and the driven-side roller Ro12. It is possible to determine whether the remaining portion Wa is conveyed to the collection box 8 based on a detection result obtained by the third conveying sensor S3. When the remaining portion Wa cannot be detected by the third conveying sensor S3 within a predetermined time after the second drive circuit 116 starts to reversely rotate the conveying motor 23, the control device 110 determines that a jam of the remaining portion Wa has occurred. When the remaining portion Wa is still detected after a predetermined time has elapsed since the remaining portion Wa is detected by the third conveying sensor S3, the control device 110 may determine that the jam of the remaining portion Wa occurs. When it is determined that the jam of the remaining portion Wa occurs, the control device 110 causes the second drive circuit 116 to stop the rotation of the conveying motor 23.

### Pressing Unit

Next, the pressing unit 6 will be described. FIG. 8 is a plan view illustrating a lower plate Mp1 and an upper plate Mp2 provided on the lower die 30. FIG. 9A is a perspective view of the pressing unit 6, and FIG. 9B is a perspective view of the pressing unit 6 viewed from a direction different from that of FIG. 9A. FIG. 10 is a diagram illustrating a standby position Psa of a pressing head 66 of the pressing unit 6, and FIG. 11 is a diagram illustrating a pressing position Psb of the pressing head 66 of the pressing unit 6.

As described above, the pressing unit 6 presses the printing medium W and the white film F against the lower die 30. Specifically, the pressing unit 6 performs cutting processing (first cutting processing) of cutting at least a part of the plurality of coupling portions Fc in the white film F disposed on the front member SE held by the lower die 30. Similarly, the pressing unit 6 performs cutting processing (second cutting processing) of cutting at least a part of the plurality of first coupling portions Wc in the printing medium W disposed on the connected portion Fb disposed on the front member SE (that is, the connected portion Fb after the first cutting processing). By the first cutting processing and the second cutting processing, the connected portion Fb and the connected portion Wb are overlapped on the front member SE held by the lower die 30. Since the first cutting processing is basically the same as the second cutting processing, the second cutting processing by the pressing unit 6 will be described below as a representative example.

As illustrated in FIG. 8, the pressing unit 6 includes the lower plate Mp1 disposed on the lower die 30 and the upper plate Mp2 disposed on the lower plate Mp1. The lower plate Mp1 includes a lower plate body 121 having a substantially rectangular plate shape and guide side walls 122 erected from left and right side edge portions of the lower plate body 121, respectively. A distance between a rear end of the left guide side wall 122 and a rear end of the right guide side wall 122 is smaller than a distance between a front end of the left guide side wall 122 and a front end of the right guide side wall 122. The distance between the rear end of the left guide side wall 122 and the rear end of the right guide side wall 122 is equal to or slightly larger than a dimension of the printing medium W in the left-right direction (that is, a width dimension) and a dimension of the white film F in the left-right direction. The guide side walls 122 facilitate positioning of the printing medium W and the white film F conveyed from the conveying unit 2 with respect to the front member SE held by the lower die 30.

The lower plate body 121 is provided with a rectangular cut 123 that opens at a front portion of the lower plate body 121, and a cut 124 that opens adjacent to a rear end of the cut 123 and protrudes rearward and has a semicircular shape. The diameter of the cut 124 is substantially the same as the diameter of a recess of the lower die 30 (that is, a holding portion of the front member SE). Bearing walls 125 are erected on left and right side edge portions of the front portion of the lower plate body 121, respectively. A bearing hole is formed in each bearing wall 125, and a plate support shaft 126 extending in the left-right direction is inserted into each bearing hole. Accordingly, the lower plate Mp1 is swingable up and down about the bearing wall 125 via the plate support shaft 126. A guide portion Bt1 (FIG. 7) bent downward is provided at a front end of the lower plate body 121. Further, guide pieces 127 extending rearward and having rear ends curved upward are provided at left and right portions of a rear end of the lower plate body 121, respectively. The guide piece 127 allows the lower plate Mp1 to smoothly ride on upper surfaces of the lower dies 30 and 31 when the lower dies 30 and 31 are pivoted, thereby facilitating positioning of the lower plate Mp1 with respect to the lower dies 30 and 31.

The upper plate Mp2 is provided with a rectangular cut 128 that opens at a rear end of the upper plate Mp2 and a semicircular cut 129 that opens adjacent to a front end of the cut 128. The diameter of the cut 128 is substantially the same as the diameter of the recess of the lower die 30 (that is, the holding portion of the front member SE). Since a rear portion of the upper plate Mp2 is cut out as described above, a rear portion of the lower plate body 121 is exposed at the rear portion.

Bearing walls 130 are erected on left and right side edge portions of a front portion of the upper plate Mp2, respectively. Each bearing wall 130 is disposed inwardly from the corresponding bearing wall 125. A bearing hole is formed in each bearing wall 130, and the above-described plate support shaft 126 is inserted into each bearing hole. Thus, the upper plate Mp2 is swingable up and down about the bearing wall 130 via the plate support shaft 126. A guide portion Bt2 bent upward is provided at a front end of the upper plate Mp2. The guide portion Bt2, together with the above-described guide portion Bt1, smoothly introduces the printing medium W and the white film F conveyed from the conveying unit 2 between the lower plate Mp1 and the upper plate Mp2.

The upper plate Mp2 and the lower plate Mp1 are disposed to overlap each other in the up-down direction. In a state in which the upper plate Mp2 and the lower plate Mp1 are disposed to overlap each other, the semicircular cut 124 of the lower plate Mp1 and the semicircular cut 129 of the upper plate Mp2 are combined with each other to form a circular opening for exposing the recesses of the lower dies 30 and 31.

The pressing unit 6 further includes the following components. As illustrated in FIGS. 9A and 9B, the pressing unit 6 includes the pressing motor 60, a pair of support plates 61, a coupling shaft 62, a swing arm 63, a support block 64, a remaining portion pressing head 65, and the pressing head 66 pressed against the printing medium W.

The pressing motor 60 is fixed to one support plate 61. A rotation shaft of the pressing motor 60 is rotatably inserted into one support plate 61. A plurality of drive gears Ga2, Ga31, Ga32, Ga41, Ga42, and Ga5 are provided between the one support plate 61 and the other support plate 61. The drive gear Ga2 is connected to the rotation shaft of the pressing motor 60. The drive gear Ga2 meshes with the drive gear Ga31. The drive gear Ga32 is provided coaxially with the drive gear Ga31. The drive gear Ga32 meshes with the drive gear Ga41. The drive gear Ga42 is provided coaxially with the drive gear Ga41. The drive gear Ga42 meshes with the drive gear Ga5. The drive gear Ga5 is provided with the coupling shaft 62 coaxially with the drive gear Ga5 and penetrating the drive gear Ga5. A base end of the swing arm 63 is coupled to the drive gear Ga5 by the coupling shaft 62. For example, a boss is provided on the drive gear Ga5 and is fitted into a recess at the base end of the swing arm 63. In such a configuration, when the pressing motor 60 is rotationally driven, a drive force thereof is transmitted to the drive gears Ga2, Ga31, Ga32, Ga41, Ga42, and Ga5.

The support block 64 is connected to a front end of the swing arm 63. The support block 64 supports the pressing head 66. When the pressing motor 60 is rotationally driven to rotate the drive gear Ga5, the swing arm 63 pivots in a pivoting direction Dr1 illustrated in FIG. 10. Specifically, for example, when the drive gear Ga5 rotates forward, the swing arm 63 pivots from a standby position Psa (FIG. 10) where the pressing head 66 stands by to the pressing position Psb (FIG. 11) where the connected portion Wb is pressed by the pressing head 66. On the other hand, for example, when the drive gear Ga5 reversely rotates, the swing arm 63 pivots from the pressing position Psb to the standby position Psa.

The remaining portion pressing head 65 includes a support shaft 65a, a head body portion 65b, and a spring 65c. A base end of the support shaft 65a is connected to the spring 65c. As illustrated in FIG. 11, the support shaft 65a extends along the conveying direction Dc2 when the pressing head 66 is at the pressing position Psb. The head body portion 65b is connected to a front end of the support shaft 65a. The head body portion 65b is located on the downstream side of the pressing head 66 in the conveying direction Dc2 when the pressing head 66 is at the pressing position Psb. When the head body portion 65b of the pressing head 66 is at the pressing position Psb, the spring 65c biases the head body portion 65b in a direction of pressing the remaining portion Wa of the printing medium W clamped between the lower plate Mp1 and the upper plate Mp2. Accordingly, the head body portion 65b presses the remaining portion Wa toward a rear end central portion 121a of the lower plate body 121.

The pressing head 66 of the pressing unit 6 presses the pressing head 66 to a lower position closer to an inner bottom surface than a placement surface of the lower die 30 (that is, a support surface of the connected portion Wb) in the second cutting processing. The pressing head 66 includes pressing ends 66a, 66b, 66c, and 66d, the first pressing portion 66e, and the second pressing portion 66f that press the connected portion Wb of the printing medium W against the lower die 30. The pressing ends 66a, 66b, 66c, and 66d, the first pressing portion 66e, and the second pressing portion 66f face the connected portion Wb of the printing medium W when the pressing head 66 is at the pressing position Psb. The pressing end 66a and the pressing end 66b are located to the left and right in the left-right direction Dy when the pressing head 66 is at the pressing position Psb. The pressing end 66c and the pressing end 66d are located in front and in the rear in the front-rear direction Dx when the pressing head 66 is at the pressing position Psb. The first pressing portion 66e is located between the pressing end 66a and the pressing end 66c. The first pressing portion 66e presses the first position Pw1 of the connected portion Wb when the pressing head 66 is at the pressing position Psb. The second pressing portion 66f is located between the pressing end 66b and the pressing end 66c. The second pressing portion 66f presses the second position Pw2 of the connected portion Wb when the pressing head 66 is at the pressing position Psb. Of the portions of the pressing head 66 facing the connected portion Wb when the pressing head 66 is at the pressing position Psb, a portion excluding the pressing ends 66a, 66b, 66c, and 66d, the first pressing portion 66e, and the second pressing portion 66f forms a spherical shape recessed upward. Thus, the above portion can be formed into a shape along a surface shape of the front member SE.

The first pressing portion 66e is formed to be located below the second pressing portion 66f when the pressing head 66 is at the pressing position Psb. Accordingly, when the swing arm 63 pivots and the pressing head 66 is disposed at the pressing position Psb in the second cutting processing, the control device 110 causes the first pressing portion 66e to press the first position Pw1 of the connected portion Wb prior to the second pressing portion 66f. That is, in the second cutting processing, the control device 110 causes the first pressing portion 66e to press the first position Pw1 of the connected portion Wb, and causes the second pressing portion 66f to press the second position Pw2 of the connected portion Wb after causing the first pressing portion 66e to press the first position Pw1 of the connected portion Wb. By the second cutting processing, at least the coupling portion Wc1 and the coupling portion Wc2 among the coupling portion Wc1, the coupling portion Wc2, and the coupling portion Wc3 of the printing medium W are cut. After the second cutting processing, the control device 110 executes the following second separation processing of cutting all the coupling portions Wc3 of the first coupling portions Wc to separate the remaining portion Wa from the connected portion Wb. After the first cutting processing, the first separation processing of cutting all the coupling portions Fc3 of the first coupling portion Fc to separate the remaining portion Fa from the connected portion Fb is basically the same as the second separation processing. Therefore, the second separation processing will be described below as a representative example.

The pressing unit 6 further includes a cutting portion 67. The cutting portion 67 is provided at the pressing end 66d. The cutting portion 67 has a triangular shape. When the first pressing portion 66e is pressed against the connected portion Wb in the range Pw1 and the second pressing portion 66f is pressed against the connected portion Wb in the range Pw2, the cutting portion 67 is located downstream, in the conveying direction Dc2, of a downstream-side end portion of the linear weak portion Wd of the printing medium W in the conveying direction Dc2. When the first pressing portion 66e is pressed against the connected portion Wb in the range Pw1 and the second pressing portion 66f is pressed against the connected portion Wb in the range Pw2, the cutting portion 67 is located such that the vertex of the triangular shape is on the upstream side in the conveying direction Dc2.

In the second separation processing, the control device 110 causes the conveying unit 2 to convey the printing medium W in the conveying direction Dc2 in a state in which a portion of the connected portion Wb is pressed by the first pressing portion 66e and the second pressing portion 66f as described above. Accordingly, the remaining portion Wa is separated from the connected portion Wb by cutting all the coupling portions Wc3. At this time, in a state in which the remaining portion Wa is pressed against the lower plate body 121 by the head body portion 65b, the linear weak portion Wd is cut by the cutting portion 67 with an end portion Wd2 of the linear weak portion Wd on the other end We2 side in the direction D1 as a starting point. Thereafter, the remaining portion Wa is conveyed to the collection box 8 by the conveying unit 2. That is, the remaining portion Wa is in a state of surrounding the pressing head 66 only by being separated from the connected portion Wb, and is caught by the pressing head 66 when being conveyed in the conveying direction Dc2 as it is. However, since the remaining portion Wa has the linear weak portion Wd and the linear weak portion Wd is cut, the remaining portion Wa is divided into a right end and a left end with the linear weak portion Wd as a boundary. The remaining portion Wa passes through the pressing head 66 while being divided into the right end and the left end with the linear weak portion Wd as the boundary. As a result, the remaining portion Wa is conveyed to the collection box 8 and collected without being caught by the pressing head 66.

FIG. 12 is a flowchart illustrating a flow of a printing medium separation method of separating the remaining portion Wa in the printing medium W from the connected portion Wb and collecting the remaining portion Wa. As illustrated in FIG. 12, of the front member SE and the back member BE of the button member CE, the front member SE is fed to the lower die 30 by the front member feeding unit 4 (step S1). Next, the printing medium W is conveyed onto the front member SE by the conveying unit 2 (step S2). Then, the connected portion Wb of the printing medium W is pressed against the lower die 30 by the pressing unit 6, so that at least a part of the first coupling portions Wc are cut (step S3).

Next, when the remaining portion Wa of the printing medium W is conveyed in the conveying direction Dc2 by the conveying unit 2 in a state in which the connected portion Wb is pressed, the linear weak portion Wd is cut by the cutting portion 67 with an end portion Wd2 of the linear weak portion Wd on the other end We2 side in the direction D1 as a starting point. Then, the remaining portion Wa after the linear weak portion Wd is cut is conveyed in the conveying direction Dc2 by the conveying unit 2 and collected in the collection box 8 (step S4).

FIG. 13A is a perspective view of the front member SE and the back member BE, and FIG. 13B is a cross-sectional view of the button product 200 manufactured by connecting the front member SE to the back member BE of FIG. 13A.

The front member SE and the back member BE each have a circular shape in a plan view. As illustrated in FIGS. 13A and 13B, the front member SE is a member in which a peripheral edge portion SEa protrudes downward, and the back member BE is a member in which a peripheral edge portion BEa protrudes upward. The button product 200 is formed by connecting, specifically crimping, the front member SE and the connected portion Wb of the printing medium W, which are held apart from each other by the upper die 33, and the back member BE. The button product 200 is, for example, a button badge. In a state in which the peripheral edge portion Fg of the connected portion Fb and the peripheral edge portion Wg of the connected portion Wb disposed on the front member SE are bent and clamped between the peripheral edge portion SEa and the peripheral edge portion BEa, the peripheral edge portion SEa and the peripheral edge portion BEa are crimped. Accordingly, the button product 200 is manufactured.

Here, a printing medium Wz described below may be used instead of the printing medium W described above. FIG. 14 is a plan view illustrating the printing medium Wz according to another example of the printing medium W described above. In FIG. 14, the same components of the printing medium Wz as those of the printing medium W in FIG. 4A are denoted by the same reference numerals, and descriptions thereof will be omitted unless otherwise specified.

As illustrated in FIG. 14, the printing medium Wz constitutes the button product 200 together with the button member CE similarly to the printing medium W, and is, for example, a transparent sheet. The printing medium Wz has a rectangular shape.

The printing medium Wz includes the sheet-shaped connected portion Wb connected to the front member SE and the back member BE by the die unit 3, the sheet-shaped remaining portion Wa different from the connected portion Wb, and adhesive portions Ws provided on the remaining portion Wa and configured to adhere the remaining portion Wa to the connected portion Wb in a manner separable from the connected portion Wb.

The remaining portion Wa is disposed to surround the connected portion Wb. The remaining portion Wa has the above-described one end We1 and the other end We2 in the direction D1. The remaining portion Wa has a circular hole portion Wah having substantially the same size as the connected portion Wb. The connected portion Wb is located in the hole portion Wah of the remaining portion Wa. The plurality of adhesive portions Ws are provided on the printing medium Wz. Specifically, the adhesive portions Ws include a first adhesive portion Ws1 provided on one side of the connected portion Wb in the direction D1 and a second adhesive portion Ws2 provided on the other side of the connected portion Wb. The first adhesive portion Ws1 and the second adhesive portion Ws2 include a mount and an adhesive layer provided on the mount except for non-adhesive portions Wm1 and Wm2 to be described later. The first adhesive portion Ws1 and the second adhesive portion Ws2 are spaced in the direction D1. At least a part of the region Rw between the first adhesive portion Ws1 and the second adhesive portion Ws2 overlaps the connected portion Wb in a plan view. Accordingly, a portion of the connected portion Wb on one side in the direction D1 is coupled to the remaining portion Wa via the first adhesive portion Ws1, and a portion of the connected portion Wb on the other side in the direction D1 is coupled to the remaining portion Wa via the second adhesive portion Ws2.

The printing medium Wz further includes a linear weak portion Wd extending from the edge portion Wh of the one end We1 to the connected portion Wb. The linear weak portion Wd has lower strength than the connected portion Wb and the remaining portion Wa.

Here, the first adhesive portion Ws1 does not overlap the linear weak portion Wd in the plan view. Specifically, the first adhesive portion Ws1 includes a first separation adhesive portion Wsd1 disposed on one side in the direction D2 and a second separation adhesive portion Wsd2 disposed on the other side in the direction D2 while being spaced from the first separation adhesive portion Wsd1. The linear weak portion Wd is disposed between the first separation adhesive portion Wsd1 and the second separation adhesive portion Wsd2. The first separation adhesive portion Wsd1 has, for example, a trapezoidal shape having an upper base parallel to the linear weak portion Wd on a linear weak portion Wd side, and the second separation adhesive portion Wsd2 has, for example, a trapezoidal shape having an upper base parallel to the linear weak portion Wd on the linear weak portion Wd side. The second adhesive portion Ws2 has, for example, a rectangular shape or a square shape.

The first separation adhesive portion Wsd1 has a first cut Nt1 provided on the other end side in the direction D1. The second separation adhesive portion Wsd2 has a second cut Nt2 provided on the other end side in the direction D1. The first cut Nt1 is cut to be separated from the linear weak portion Wd to one side in the direction D2 as it goes in the conveying direction Dc2, and the second cut Nt2 is cut to be separated from the linear weak portion Wd to the other side in the direction D2 as it goes in the conveying direction Dc2. That is, a first interval It1 in the direction D2 between the other end side end portion of the first cut Nt1 in the direction D1 and the other end side end portion of the second cut Nt2 in the direction D1 is larger than a second interval It2 in the direction D2 between one end side end portion of the first cut Nt1 in the direction D1 and one end side end portion of the second cut Nt2 in the direction D1.

Here, when the remaining portion Wa of the printing medium Wz is separated from the connected portion Wb, the pressing head 66 is pressed against the connected portion Wb in a manner similar to that in the second cutting processing described above. Accordingly, the adhesion between the connected portion Wb and the remaining portion Wa by the second adhesive portion Ws2 is released. Then, when the remaining portion Wa is conveyed in the conveying direction Dc2 by the conveying unit 2 as in the second separation processing described above, the adhesion between the connected portion Wb and the remaining portion Wa by the first adhesive portion Ws1 (that is, the first separation adhesive portion Wsd1 and the second separation adhesive portion Wsd2) is released. The remaining portion Wa of the printing medium Wz is separated from the connected portion Wb by this flow.

A non-adhesive portion Wm1 having no adhesive layer is provided on the downstream side in the conveying direction Dc2 in the first separation adhesive portion Wsd1, and a non-adhesive portion Wm2 having no adhesive layer is provided on the downstream side in the conveying direction Dc2 in the second separation adhesive portion Wsd2. That is, the non-adhesive portions Wm1 and Wm2 are portions formed only of the mount. Accordingly, the first separation adhesive portion Wsd1 does not adhere the connected portion Wb in the non-adhesive portion Wm1, and the second separation adhesive portion Wsd2 does not adhere the connected portion Wb in the non-adhesive portion Wm2. By providing the non-adhesive portions Wm1 and Wm2, when the remaining portion Wa is conveyed in the conveying direction Dc2 to separate the remaining portion Wa from the connected portion Wb, the first separation adhesive portion Wsd1 and the second separation adhesive portion Wsd2 easily ride on the pressing head 66 and are conveyed. The configuration of the printing medium Wz described above is similarly applied to the white film constituting the button product 200 together with the printing medium Wz.

As described above, according to the printing media W and Wz of the present embodiment, the remaining portion Wa can be easily separated from the connected portion Wb by cutting the first coupling portions Wc in the printing medium W conveyed onto the front member SE. Accordingly, only the connected portion Wb can be positioned and disposed on the front member SE with high accuracy.

Further, in the present embodiment, more first coupling portions Wc are provided in the predetermined range Pw3 on the boundary between the connected portion Wb and the remaining portion Wa than in the range Pw1 and the range Pw2. That is, the number of the coupling portions Wc3 is larger than the total number of the coupling portions Wc1 and the coupling portions Wc2. Accordingly, in the second cutting processing of cutting the first coupling portions Wc in the printing medium W, it is more difficult to cut the coupling portion Wc3 in the range Pw3 is than the coupling portions Wc1 and Wc2 in the ranges Pw1 and Pw2. That is, in the second cutting processing, it is possible to avoid cutting all the first coupling portions Wc. Accordingly, it is possible to prevent the pressing of the pressing head 66 against the connected portion Wb from reaching the entire connected portion Wb, and thus deformation of the connected portion Wb due to the pressing can be prevented.

In the present embodiment, the connected portion Wb is located closer to the one end We1 than the other end We2 of the remaining portion Wa. That is, the connected portion Wb is unevenly distributed toward the one end We1 with respect to the remaining portion Wa. Accordingly, in the second separation processing of separating the remaining portion Wa from the connected portion Wb, the length of the linear weak portion Wd to be cut by the cutting portion 67 can be shortened. Therefore, the remaining portion Wa is easily divided into the right end and the left end with the linear weak portion Wd as the boundary.

In the present embodiment, the strength of the linear weak portion Wd is smaller than that of the connected portion Wb and the remaining portion Wa. Accordingly, when the remaining portion Wa is conveyed in the conveying direction Dc2 by the conveying unit 2 in the second separation processing, the linear weak portion Wd is easily cut by the cutting portion 67.

Further, in the present embodiment, the linear weak portion Wd has the edge side coupling portion Wd1 coupled to the edge portion Wh of the remaining portion Wa. Accordingly, it is difficult to cut the linear weak portion Wd by an external pressure before the second cutting processing and the second separation processing are executed (for example, during conveying). Therefore, it is possible to convey the printing medium W while maintaining the shape of the printing medium W.

In the present embodiment, the first cut portion Wf and the second cut portion Wd4 are continuous. That is, in the region Re, the connected portion Wb is cut in an inverted T shape with respect to the remaining portion Wa. Accordingly, after the linear weak portion Wd is cut by the cutting portion 67 in the second separation processing, the remaining portion Wa is easily divided into the right end and the left end with respect to the connected portion Wb.

Further, in the present embodiment, the mark portion MR disposed on one side in the direction D2 with the center in the direction D2 as a reference is provided on the remaining portion Wa. Accordingly, when the user accommodates the printing medium W in the sheet holder of the printing unit 1, the front and back surfaces and an arrangement orientation of the printing medium W are less likely to be wrong.

Further, according to the printing medium Wz of the present embodiment, in the printing medium Wz conveyed onto the front member SE, the adhesion between the connected portion Wb and the remaining portion Wa by the second adhesive portion Ws2 is released, and the adhesion between the connected portion Wb and the remaining portion Wa by the first adhesive portion Ws1 is released. Accordingly, the remaining portion Wa can be easily separated from the connected portion Wb. Therefore, only the connected portion Wb can be positioned and disposed on the front member SE with high accuracy.

In the present embodiment, the plurality of adhesive portions Ws are provided on the printing medium Wz. Specifically, the adhesive portions Ws include the first adhesive portion Ws1 provided on one side of the connected portion Wb in the direction D1 and the second adhesive portion Ws2 provided on the other side of the connected portion Wb. At least a part of the region Rw between the first adhesive portion Ws1 and the second adhesive portion Ws2 overlaps the connected portion Wb in the plan view. Accordingly, it is possible to avoid providing the adhesive portion on the entire surface of the connected portion Wb, and thus it is possible to prevent deformation of the connected portion Wb caused by providing the adhesive portion.

In the present embodiment, the first adhesive portion Ws1 does not overlap the linear weak portion Wd in the plan view. The linear weak portion Wd is disposed between the first separation adhesive portion Wsd1 and the second separation adhesive portion Wsd2. Accordingly, when the remaining portion Wa is conveyed in the conveying direction Dc2 by the conveying unit 2, it is possible to avoid that it becomes difficult to cut the linear weak portion Wd by the cutting portion 67 due to the presence of the adhesive portion.

Further, in the present embodiment, the first interval It1 in the direction D2 between the other end side end portion of the first cut Nt1 in the direction D1 and the other end side end portion of the second cut Nt2 in the direction D1 is larger than the second interval It2 in the direction D2 between the one end side end portion of the first cut Nt1 in the direction D1 and the one end side end portion of the second cut Nt2 in the direction D1. Accordingly, after the linear weak portion Wd is cut by the cutting portion 67, the remaining portion Wa is easily divided into the right end and the left end with the linear weak portion Wd as the boundary. Therefore, the remaining portion Wa after the division is conveyed in the conveying direction Dc2 and collected without interfering with the pressing unit 6.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### Modification

The present disclosure is not limited to the above-described embodiment, and modifications can be adopted without departing from the gist of the present disclosure. For example, it is as follows.

In the above embodiment, the connected portion Wb has a circular shape in the plan view, but the shape is not limited thereto and may be another shape such as an elliptical shape.

In the above embodiment, the coupling portions Wc1 and the coupling portions Wc2 are arranged at equal intervals, but the present disclosure is not limited thereto, and the coupling portions Wc1 and the coupling portions Wc2 may be arranged at unequal intervals. The coupling portions Wc3 are arranged at unequal intervals, but the present disclosure is not limited thereto, and the coupling portions Wc3 may be arranged at equal intervals.

Further, in the embodiment described above, two adhesive portions, that is, the first adhesive portion Ws1 and the second adhesive portion Ws2 are provided in the direction D1, but the disclosure is not limited thereto, and three or more adhesive portions may be provided.

In addition, in the embodiment described above, the shape of each of the first separation adhesive portion Wsd1 and the second separation adhesive portion Wsd2 is the trapezoidal shape in the plan view, and the shape of the second adhesive portion Ws2 is the rectangular shape or the square shape in plan view, but the disclosure is not limited thereto. The shapes of the first separation adhesive portion Wsd1, the second separation adhesive portion Wsd2, and the second adhesive portion Ws2 are not particularly limited and can be freely determined as long as adhesion between the connected portion Wb and the remaining portion Wa is achieved.

In addition, in the embodiment described above, the mark portion MR is disposed on one side of the direction D2 with the center in the direction D2 as a reference in the remaining portion Wa of the printing media W and Wz, but the disclosure is not limited thereto. The mark portion MR may be disposed on the other side of the direction D2 with the center of the remaining portion Wa in the direction D2 as a reference. In order to further improve the visibility of the user, it is desirable to provide the mark portion MR in a region having a relatively large space in the remaining portion Wa (that is, a region away from the region where the connected portion Wb and the coupling portion Wc are provided).

The control device 110 may cause the second drive circuit 116 to drive the conveying unit 2 after an image is printed on the printing medium W by the printing unit 1, instead of causing the second drive circuit 116 to drive the conveying motor 23 when the printing medium W is detected by the first conveying sensor S1. The control device 110 may cause the second drive circuit 116 to drive the conveying unit 2 before an image is printed on the printing medium W by the printing unit 1, instead of causing the second drive circuit 116 to drive the conveying motor 23 when the printing medium W is detected by the first conveying sensor S1. Further, the control device 110 may cause the second drive circuit 116 to drive the conveying unit 2 when an image is printed on the printing medium W by the printing unit 1, instead of causing the second drive circuit 116 to drive the conveying motor 23 when the printing medium W is detected by the first conveying sensor S1.

What is claimed is:

1. A printing medium configured to constitute, together with a button member, a button product, the printing medium comprising:
a connected portion having a sheet shape and configured to be connected to the button member;
a remaining portion having a sheet shape and different from the connected portion; and
at least one first coupling portion coupling the connected portion to the remaining portion.

2. The printing medium according to claim 1,
wherein the at least one first coupling portion comprises a plurality of first coupling portions provided on a boundary between the connected portion and the remaining portion,
wherein the printing medium further comprises a first cut portion located between adjacent ones of the plurality of first coupling portions and provided on the boundary,
wherein the plurality of first coupling portions comprise two or more first-range coupling portions provided in a first range that is a range on the boundary and one or more second-range coupling portions provided in a second range that is a range different from the first range, and
wherein a number of the two or more first-range coupling portions is greater than a number of the one or more second-range coupling portions.

3. The printing medium according to claim 1,
wherein the remaining portion is disposed to surround the connected portion and has one end and another end in a predetermined direction, and
wherein the connected portion is located closer to the one end than to the another end.

4. The printing medium according to claim 3, further comprising:
a linear weak portion extending from an edge portion of the one end to the connected portion and having a strength smaller than that of the connected portion and that of the remaining portion.

5. The printing medium according to claim 4,
wherein the linear weak portion has an edge side coupling portion coupled to the edge portion of the remaining portion.

6. The printing medium according to claim 4,
wherein the remaining portion comprises a first remaining area on one side of the linear weak portion and a second remaining area on another side of the linear weak portion,
wherein the linear weak portion comprises a second coupling portion coupling the first remaining part and the second remaining area to each other and a second cut portion by which a part of the remaining portion between the first remaining area and the second remaining area is cut, and
wherein the first cut portion and the second cut portion are continuous with each other.

7. The printing medium according to claim 3,
wherein the remaining portion comprises a mark portion disposed on one side of an intersecting direction with respect to a center in the intersecting direction that intersects with the predetermined direction as a reference.

8. A printing medium configured to constitute, together with a button member, a button product, the printing medium comprising:
a connected portion having a sheet shape and configured to be connected to the button member;
a remaining portion having a sheet shape and different from the connected portion; and
at least one adhesive portion provided on the remaining portion and configured to adhere the remaining portion to the connected portion to allow the remaining portion to be separated from the connected portion.

9. The printing medium according to claim 8,
wherein the at least one adhesive portion comprises a plurality of adhesive portions.

10. The printing medium according to claim 8,
wherein the remaining portion is disposed to surround the connected portion, and
wherein the at least one adhesive portion comprises a first adhesive portion provided on one side of the connected portion in a predetermined direction and a second adhesive portion provided on another side of the connected portion.

11. The printing medium according to claim 10,
wherein at least a part of a region between the first adhesive portion and the second adhesive portion overlaps the connected portion in a plan view.

12. The printing medium according to claim 11,
wherein the remaining portion is disposed to surround the connected portion and has one end and another end in the predetermined direction,
wherein the printing medium further comprises a linear weak portion extending from an edge portion on one end side to the connected portion and having a strength smaller than that of the connected portion and that of the remaining portion, and
wherein the first adhesive portion does not overlap the linear weak portion in the plan view.

13. The printing medium according to claim 12,
wherein the first adhesive portion comprises a first separation adhesive portion disposed on one side in an intersecting direction intersecting the predetermined direction and a second separation adhesive portion disposed on another side in the intersecting direction while being spaced from the first separation adhesive portion,
wherein the first separation adhesive portion includes a first cut provided on an another end side in the predetermined direction,
wherein the second separation adhesive portion includes a second cut provided on the another end side in the predetermined direction, and
wherein a first interval in the intersecting direction between an end portion of the first cut on the another end side in the predetermined direction and an end portion of the second cut on the another end side in the predetermined direction is larger than a second interval in the intersecting direction between an end portion of the first cut on the one end side in the predetermined direction and an end portion of the second cut on the one end side in the predetermined direction.

14. A printing medium separation method for separating, in the printing medium according to claim 4, the remaining portion from the connected portion, the method comprising:
feeding, to a lower die, a front member among the front member and a back member provided in the button member;
conveying the printing medium onto the front member;
pressing the connected portion of the printing medium against the lower die to cut at least a part of the first coupling portion;
cutting, by a cutting portion, the linear weak portion from, as a starting point, an end portion of the linear weak portion on another end side in the predetermined direction when the remaining portion of the printing medium is conveyed in a conveying direction in a state in which the connected portion is pressed; and
conveying, in the conveying direction, the remaining portion with the linear weak portion being cut.
